(19) United States
(12) Patent Application Publication
(10) Pub. No.: US 2008/0198996 A1
(43) Pub. Date: Aug. 21, 2008

(54) Methods, systems, and computer program products for using a location routing number based query and response mechanism to effect advanced routing

(75) Inventors: Apirux Bantukul, Cary, NC (US); Peter J. Marsico, Chapel Hill, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(73) Assignee: Tekelec

(21) Appl. No.: 11/731,800

(22) Filed: Mar. 30, 2007

Related U.S. Application Data
(60) Provisional application No. 60/902,585, filed on Feb. 21, 2007.

(51) Int. Cl. H04M 7/00

(52) U.S. Cl. 379/220.01; 379/201.01

(57) ABSTRACT

The subject matter described herein includes methods, systems, and computer program products for using a location routing number (LRN) based query and response mechanism to effect advanced routing. According to one aspect, a method includes receiving a location routing number (LRN) based query and generating an advanced routing query based on the LRN based query. The generated advanced routing query is sent to an advanced routing function configured to process the advanced routing query. Upon receiving an advanced routing response including a carrier ID from the advanced routing function, a location routing number (LRN) is determined based on the advanced routing response. In response to successfully determining an LRN based on the advanced routing response, an LRN based response including the determined LRN is generated.

### RELATED APPLICATIONS

The presently disclosed subject matter claims the benefit of U.S. Provisional Patent Application Ser. No. 60/902,585, filed Feb. 21, 2007; the disclosure of which is incorporated herein by reference in its entirety.

### TECHNICAL FIELD

The subject matter described herein relates to providing advanced routing services. More particularly, the subject matter described herein relates to using a location routing number based query and response mechanism to effect advanced routing, such as least cost routing.

### BACKGROUND

Local number portability (LNP) allows telephone service subscribers to retain their same directory numbers when switching between geographic locations and/or telecommunications service providers. Local number portability was mandated by the Telecommunications Act of 1996.

Local number portability is made possible by a location routing number (LRN). When a subscriber's local service is moved to a new end office, the LRN associated with the ported-to end office is associated with the ported directory number in a number portability database. When a call is made to the ported directory number, the originating end office sends a query to a number portability database. The number portability database returns the LRN of the ported-to end office. The end office uses the LRN to route the call to the ported-to end office.

Number portability data is administered by a national number portability administration center (NPAC). The NPAC distributes number portability data to local systems maintained by service providers, which are referred to as local service management systems (LSMS). The local service management systems in turn populate the number portability databases maintained by each carrier.

As the number of ported directory numbers has increased, switching office processing functionality for launching number portability queries and processing number portability responses has become common. That is, switching offices typically include software implemented triggers to launch number portability queries and process the responses. Conventionally, these triggers have been used for number portability processing only. However, it may be desirable to use or leverage this processing capability for other purposes.

One purpose for which it may be desirable to utilize switching office number portability processing functionality is to implement advanced routing (AR) services in a communications network. Examples of advanced routing include least cost routing (LCR), time of day-day of week routing, service level agreement routing, and differential quality of service (QoS) routing. Least cost routing occurs when a packet is routed to a destination via the least expensive route. Time of day-day of week routing, which is often associated with LCR, occurs when a routing for a call is based on the time of day and/or day of week that the call attempt is made. Service level agreement routing occurs when a communications service provider has entered into service agreements (e.g., business contracts) with other communications service providers that dictate how certain calls should be routed. Differential QoS routing occurs when a routing for a call is based on the quality of service associated with a communications service subscriber. In the case of LCR routing, determination of the least cost route to a destination is made by obtaining least cost routing information. For example, in signaling system 7 (SS7) communications networks, least cost routing (LCR) information is typically obtained by querying an LCR database. An end office switch may generate an intelligent network/advanced intelligent network (IN/AIN) LCR query including a called party number (CdPN) or other communications service subscriber identifier. This query is then typically sent to an LCR database, such as a service control point (SCP), which determines the carrier ID associated with the CdPN and other LCR information contained in the database, such as the time of day.

An LCR SCP then typically generates an LCR response that includes the determined carrier ID, and sends the response to the end office switch query originator. Upon receiving the LCR response, a conventional end office uses the carrier ID included in the LCR response to determine an LRN associated with the carrier ID and sets up the call.

One problem associated with conventional methods for implementing least cost routing is that extensive logic must be located at each switching office in order to determine the LRN associated with the least cost route for a particular carrier ID. For example, one possible implementation is to configure each end office with an LCR trigger to query an LCR database for calls to certain subscribers. Implementing LCR triggers at end offices would be burdensome to carriers because end office hardware and/or software would require upgrading. The burden would be increased for carriers with multiple end office facilities to upgrade.

Accordingly, in light of these difficulties, there exists a need for methods, systems, and computer program products for using LRN based query and response mechanisms to implement advanced routing services in a communications network.

### SUMMARY

The subject matter described herein includes methods, systems, and computer program products for using a LRN based query and response mechanism to effect least cost routing. According to one aspect, a method includes receiving an LRN based query, such as a number portability (NP) query, and generating an advanced routing (AR) query, such as a least cost routing (LCR) query, based on the LRN based query. The generated advanced routing query is sent to an advanced routing function configured to process the advanced routing query. Upon receiving an advanced routing response from the advanced routing function that includes a carrier ID, a location routing number (LRN) is determined based on the advanced routing response. In response to successfully determining an LRN based on the advanced routing response, an LRN based response including the determined LRN is generated.

According to another aspect of the subject matter described herein, an LRN based query, such as an NP query, including a communications service subscriber identifier (CSSI), such as a called party number (CdPN), is received. An LRN is determined based on the CSSI and associated advanced routing information. In response to determining an LRN, a LRN based response including the determined LRN is generated.

The subject matter described herein for using an LRN based query and response mechanism to effect advanced routing may be implemented in hardware, software, firmware, or any combination thereof. As such, the terms “function” or “module” as used herein refer to hardware, software, and/or firmware for implementing the feature being described. In one exemplary implementation, the subject matter described herein may be implemented using a computer program product comprising computer executable instructions embodied in a computer readable medium. Exemplary computer readable media suitable for implementing the subject matter described herein include disk memory devices, chip memory devices, programmable logic devices, application specific integrated circuits, and downloadable electrical signals. In addition, a computer program product that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings of which:

FIG. 1 is an exemplary system for using a location routing number based query and response mechanism to effect advanced routing according to an embodiment of the subject matter described herein;

FIG. 2 is a flow chart of an exemplary process for using a location routing number based query and response mechanism to effect advanced routing in the communications network shown in FIG. 1 according to an embodiment of the subject matter described herein;

FIG. 3 is a block diagram of an exemplary communications network including a signaling message routing node configured to perform location routing number based advanced routing services according to an embodiment of the subject matter described herein;

FIG. 4 is a flow chart of an exemplary process for using a location routing number based query and response mechanism to effect advanced routing according to an embodiment of the subject matter described herein;

FIG. 5 is an exemplary system for using a location routing number based query and response mechanism to effect advanced routing for a foreign roaming mobile subscriber according to an embodiment of the subject matter described herein;

FIG. 6 is an exemplary system for using a location routing number based query and response mechanism to effect advanced routing for a foreign roaming mobile subscriber according to an embodiment of the subject matter described herein; and

FIG. 7 is an exemplary signal transfer point (STP) routing node including a location routing number based advanced routing function according to an embodiment of the subject matter described herein.

### DETAILED DESCRIPTION

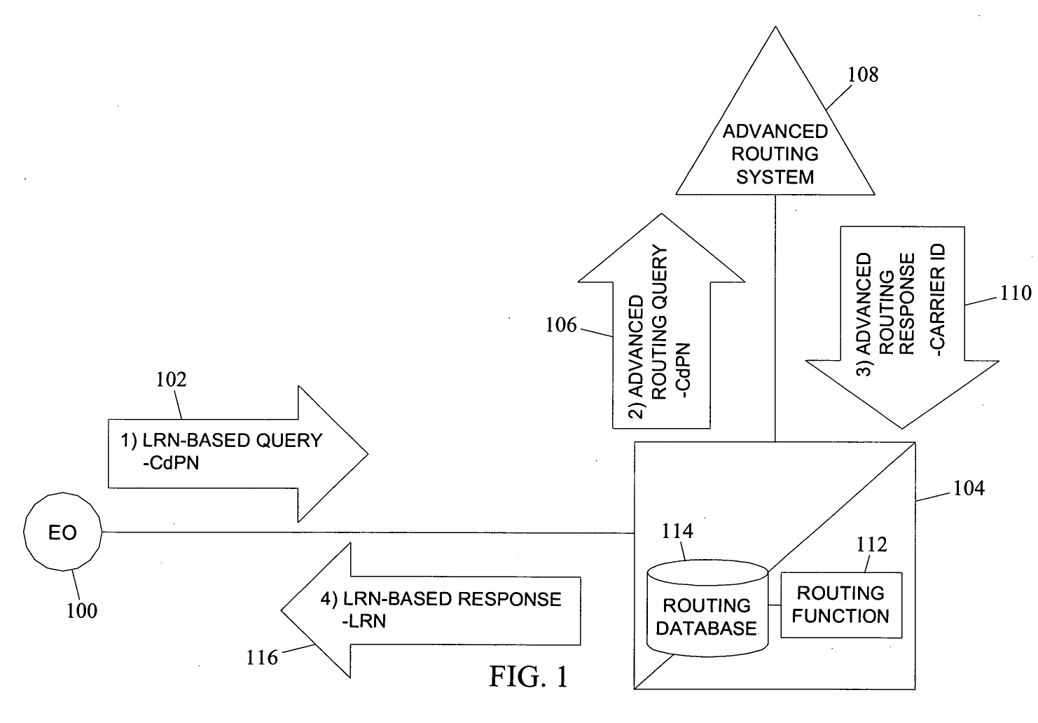

Methods, systems and computer program products for using an LRN based query and response mechanism, such as a number portability query and response mechanism effect advanced routing according to embodiments of the subject matter described herein may be implemented in any suitable network device or devices. For example, the methods, systems, and computer program products may be implemented in a routing node, a signal transfer point (STP), a router, a switch, a gateway, or other suitable network device. FIG. 1 illustrates an exemplary system for effecting least cost routing using an LRN based query and response mechanism according to an embodiment of the subject matter described herein. Referring to FIG. 1, originating EO switch 100 may generate an LRN based query 102. The generated LRN based query 102 may be, for example, an intelligent network (IN) query, advanced intelligent network (AIN) query, intelligent network application part (INAP) initial detection point (IDP) query, customized applications for mobile networks enhanced logic (CAMEL) query, or any other suitable query implementing query/response-based networking protocols. In this example, query 102 comprises a number portability query. The expected response to the LRN based query is an LRN based response that includes information identifying the location of the ported-to end office switch, such as an LRN. For example, EO 100 may send an InfoAnalyzed query 102 including a called party number (CdPN) to a signaling message routing node 104.

In response to receiving query 102, node 104 may generate an advanced routing query based on information in NP query 102. For example, node 102 may generate advanced routing query 106 based on NP query 102. Both NP query 102 and advanced routing query 106 may contain a communications service subscriber identifier (CSSI), such as a CdPN. Additional information from NP query 102 may be cached and extracted and used later for generating a NP response. Upon receiving advanced routing query 106, node 104 may route query 106 to advanced routing system (AR 108 for processing. Advanced routing system 108 may include an advanced routing function and an advanced routing database, which are used to generate advanced routing responses based on received advanced routing queries. Advanced routing function may locate data stored in advanced routing database in order to locate a carrier ID associated with the CdPN included in the advanced routing query message. This information may then be inserted into an advanced routing response message. For example, in response to receiving query 106, advanced routing system 108 may retrieve a carrier ID from its database based on the called party number. advanced routing system 108 may return an advanced routing response message 110 including a carrier ID that indicates the network carrier associated with the called party number.

Upon receiving advanced routing response message 110, node 104 may generate a NP response message based on the information received in advanced routing response 110. For example, routing function 112 and routing database 114 may use advanced routing response message 110 to generate NP response message 116. Based on the carrier ID in advanced routing response message 110, routing function 112 may search routing database 114 for a location routing number (LRN) associated with the carrier ID. Upon determining the LRN associated with the carrier ID included in advanced routing response message 110, node 104 may insert the LRN into NP response message 116, which may be routed to EO 100.

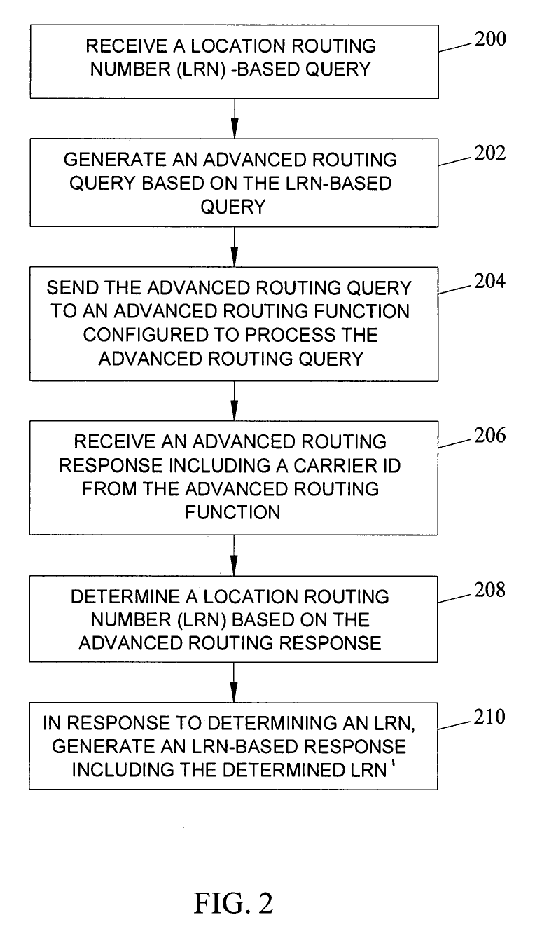

FIG. 2 is a flow chart illustrating an exemplary process for using an LRN based query and response mechanism to effect least cost routing according to an embodiment of the subject matter described herein. In the example illustrated in FIG. 2, it is assumed that the LRN based query is a number portability query. Referring to FIG. 2, in block 200, an NP query including a communications service subscriber identifier, such as a called party number, may be received. For example, node 104 may receive NP query 102. NP query 102 may be an InfoAnalyzed query including a CdPN, or any other IN/AIN query which expects an LRN as a response.

In block 202, upon receiving the NP query, an advanced routing query based on the NP query may be generated. For example, routing node 104 may extract and cache information contained in NP query 102, such as a CdPN, and include the information in generated advanced routing query 106. It is appreciated that advanced routing query 106 may include for example, an intelligent network (IN) query, advanced intelligent network (AIN) query, intelligent network application part (INAP) initial detection point (IDP) query, customized applications for mobile networks enhanced logic (CAMEL) query, or any other suitable query implementing query/response-based networking protocols.

In block 204, the advanced routing query generated in block 202 may be sent to an advanced routing system for processing. The advanced routing system may be any system configured to receive an advanced routing query and generate an advanced routing response. An exemplary advanced routing system may include an LCR service control point (SCP). For example, node 102 may send LCR query 106 to LCR system 108. LCR query 106 may include a CdPN and may be used by LCR system 108 to locate a carrier ID associated with the CdPN. LCR system 108 may generate an LCR response including the located carrier ID and send it to node 104. For example, LCR 108 may generate and send LCR response 110 including a carrier ID to node 104.

In block 206, the advanced routing response generated by advanced routing system 108 is received. The advanced routing response is used to determine an LRN associated with the least cost route for the CdPN included in NP query 102 (block 208). For example, node 104 may receive advanced routing response 110, that includes a carrier ID value, and determine an LRN to be included in NP response 116. Node 104 may include routing function 112 and routing database 116. Routing function 112 may be configured to search routing database 116 for an LRN associated with least cost routing, time of day -day of week routing, service level agreement routing, and differential quality of service (QoS) routing. Routing function 112 may be further configured to generate LRN based response messages, such as NP response messages, based on information retrieved from routing database 114 or other received messages. Routing database 114 may be configured to store number portability and least cost routing information, such as the information shown in Table 1 below.

Table 1 below shows exemplary entries in a database for associating a carrier ID with a least cost route LRN.

TABLE 1
Exemplary Entries for Associating a Carrier ID with a Least
Cost Route LRN

| | | Time | | |
|---|---|---|---|---|
| | | Begin | Time | |
| Carrier ID | CdPN | Range | End Range | LRN |
| 12 | * | 6 am | 10 am | 9195550000 |
| 12 | * | 10 am | 6 am | 9195550001 |
| 34 | 9194691010 | * | * | 9195550002 |

The entries shown in Table 1 may be stored, for example, in routing database 114. Referring to Table 1, the first column contains carrier ID values identifying different network carriers operating within a communications network environment. The second column contains called party numbers (CdPNs) corresponding to a destination end office switch. The third and fourth columns specify times, which may be used to differentiate multiple entries sharing a single carrier ID. The cost of a communications route connecting a calling party number to a destination switch may vary based on the time the call was placed. For example, a network carrier may provide lower rates for calls traversing predetermined routes during off-peak times in order to reduce the dropoff in call volume between peak and off-peak times. The fifth column contains LRNs indicating the location of an end office switch. When an LCR response message is received, the carrier ID included in the response is used to locate an associated LRN. In some instances, a single carrier ID may be associated with multiple LRNs. In such cases, information extracted and cached from the originating NP query may be used to determine the proper LRN to include in the NP response message. For example, routing node 104 may receive NP query 102 including a CdPN of 9194690000 at 8 am. Routing function 112 may then extract and cache information contained in NP query 102 and generate LCR query 106 including the CdPN. Node 104 may then send LCR query 106 to LCR system 108, which locates a carrier ID 12 associated with CdPN 9194690000. LCR system 108 may then generate LCR response 110 including carrier ID 12, and send it to node 104.

Upon receiving LCR response 110, routing node 104 may perform a lookup in Table 1 for carrier ID 12 for an associated LRN. Referring to Table 1, carrier ID 12 included in LCR response 110 is used to search routing database 114. This search may be performed by routing function 112 and results in locating two matching entries corresponding to LRNs 9195550000 and 9195550001. Thus, information in addition to the carrier ID may be needed in order to determine the LRN associated with the least cost route for the CdPN. Referring to the second column of Table 1, the CdPN 9194690000 does not help differentiate between the two entries for carrier ID 12. Therefore, routing node 104 may use the values in columns 3 and 4 of Table 1 to differentiate the entries and determine the appropriate LRN. Because the call time value extracted and cached from NP query 102 is 8 am, node 104 determines that LRN 9195550000 is the LRN associated with the least cost route and is included in NP response 116. Alternatively, if the call time value for the same carrier ID and CdPN equaled 12 pm, node 104 would determined that LRN 9195550001 should be included in NP response 116.

Thus, based on the CdPN information in column 2 and time range information in columns 3 and 4, a call placed to a destination carrier ID 12 between 6 am and 10 am has a least cost route corresponding to an end office switch associated with LRN 9195550000. Calls placed between 10 am and 6 am with the same carrier ID have a least cost route corresponding to a switch associated with LRN 9195550001. In a third example illustrated in Table 1, calls with a carrier ID of 34 included in LCR response 110 have a least cost route corresponding to a switch associated with LRN 9195550002.

In block 210, routing node 104 may generate a NP response message including a LCR LRN. For example, node 104 may generate NP response 116 that includes an LRN. NP response 116 may be any suitable IN/AIN response message that includes an LRN, such as an AnalyzeRoute response.

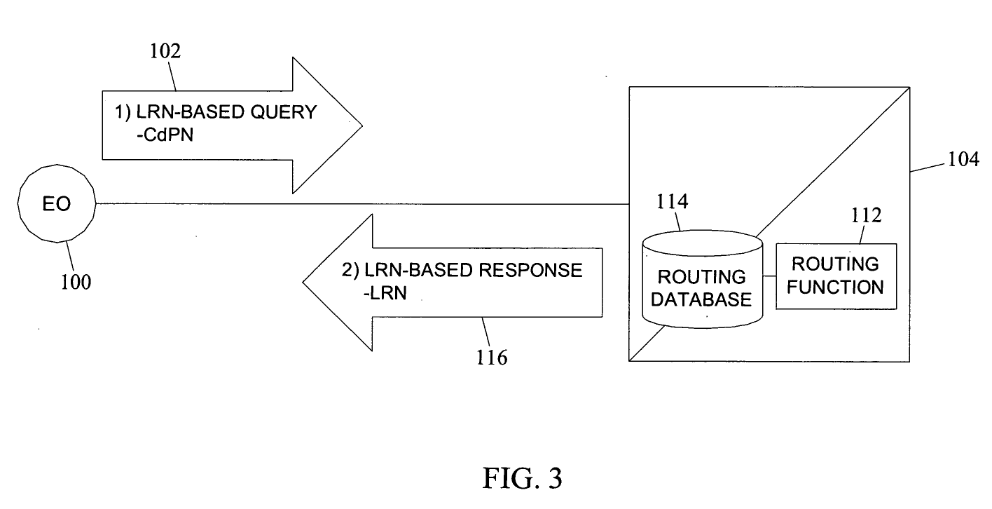

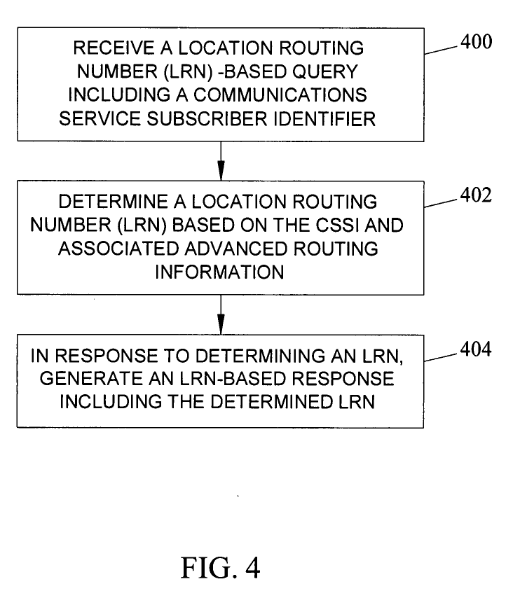

In the examples illustrated in FIGS. 1 and 2, the LCR lookup was performed on an LCR SCP. In an alternate embodiment, the LCR lookup may be performed using an LCR database internal to routing node 104. FIGS. 3 and 4 illustrate such an embodiment.

FIG. 3 is a block diagram illustrating an exemplary communications network for using a LRN based query and response mechanism effect advanced routing according to an embodiment of the subject matter described herein. Routing function 112 of routing node 104 may receive query 102 and extract the called party number from query 102. Based on the called party number in query 102, routing function 112 may determine, for example, a least cost route LRN associated with the called party number. For example, routing function 112 may search routing function database 114 for a least cost route LRN associated with the called party number. If a least cost route LRN associated with the called party number is found, function 112 may generate an AnalyzeRoute response message 116 including the least cost route LRN. Message 116 may be routed to end office 100. As a result, function 112 may operate on behalf of an NP system.

FIG. 4 is a flow chart illustrating exemplary steps for using a LRN based query and response mechanism to effect advanced routing according to an embodiment of the subject matter described herein. Referring to FIG. 4, in block 400, an LRN based query including a CSSI may be received. For example, node 104 may receive InfoAnalyzed query 102 including a called party number from end office 100.

In block 402, an LRN may be determined based on the CSSI contained in the received LRN based query and other advanced routing information. The determination may be made by performing a lookup in an advanced routing information data structure. For example, routing node 104 may use the CdPN included in LRN based query 102 to search a data structure, such as illustrated in Table 2 below, for an LRN associated with the LCR for the CdPN and time value associated with the call.

Table 2 below shows exemplary entries in a database for associating a called party number with a least cost route LRN.

TABLE 2
Exemplary Entries for Associating a Called Party Number
with a Least Cost Route LRN

| | Time | Time | |
|---|---|---|---|
| CdPN | Begin Range | End Range | LRN |
| * | 6 am | 10 am | 9195550000 |
| * | 10 am | 6 am | 9195550001 |
| 9194691010 | * | * | 9195550002 |

The entries shown in Table 2 may be stored, for example, in routing database 114. Referring to Table 2, the first column contains called party numbers, where * is a “don't care” value representing any CdPN. The second and third columns specify times, which may be used to differentiate multiple entries sharing a single carrier ID. The fourth column contains location routing numbers (LRNs) indicating the location of an end office switch. In Table 2, the first two entries are associated with all CdPNs, while the third entry specifies CdPN 9194691010. In the event that a query including CdPN 9194691010 is received, the LRN associated with the most specific CdPN information is used, which in the example illustrated in Table 2 is LRN 9195550002. The CdPNs located in the first column are used to locate an LRN in the fourth column, which is then used to generate a NP response. In Table 2, the first two entries share CdPNs. In order to determine the proper LRN, time range information located in columns 2-3 is used. In the example, for calls to any TN other than 9194691010 between 6 am and 10 am, the proper LRN for the call is 9195550000. On the other hand, for similar calls placed between 10 am and 6 am, the proper LRN for the call would be 9195550001.

In block 404, an LRN based response may be generated in response to successfully determining an LRN associated with the CSSI contained in the LRN based query as well as other advanced routing information. Further, the determined LRN may be included in the generated LRN based response message. For example, routing node 104 may generate AnalyzeRoute response 116 including a least cost route LRN. Upon receiving response 116, end office 100 may set-up the call to the destination switch indicated by the LRN included in message 116 without any further processing.

Thus, node 104 may be configured to receive an NP query, determine the least cost route LRN based on the query, and generate a NP response including the LRN. The determination made by node 104 combines and replaces separate NP and LCR lookups by NP and LCR SCPs and processing performed by the EO in conventional systems.

In one embodiment, in order for EO 100 to differentiate between an LRN included in an LRN based response message that is associated with a least cost route and an LRN included in a conventional LRN based response message that includes an LRN that may or may not be associated with the lowest cost route, EO 100 may perform additional processing associated with each LRN based query. For example, EO 100 may maintain a table including transaction IDs that uniquely identify each query transaction. Each transaction ID may be associated with a value determined by EO 100 that indicates whether the LRN included in LRN based response 116 is associated with the lowest cost route.

Similarly, in order for advanced routing node 104 to differentiate between LRN based queries requiring advanced services and queries requiring conventional processing, node 104 may perform additional processing associated with each received LRN based query. For example, advanced routing node 104 may determine whether to perform advanced routing services based on a point code (PC) and subsystem number (SSN) included in query 102. Node 104 may generate advanced routing query 106 only after receiving LRN based queries including specific a PC+SSN or within a specified range of PC+SSNs.

In another example, global title translation type (TT) values may be used to determine whether to generate advanced routing query 106. LRN based query 104 may include a TT value corresponding to a service located on node 104. The TT value included in query 102 may be translated by node 104 into information for identifying the service on node 104. The services identified by TT values may be privately defined by a carrier and therefore allows for greater customizability and flexibility when implementing advanced routing services.

### Calling Party-Based Advanced Routinq

According to another embodiment of the subject matter described herein, an LNP or LNP-like query is generated by a switching office, where the query includes a calling party identifier. A communications service provider may use this type of calling party-based advanced routing to implement differential QoS within their network, where QoS for a call is based at least in part on the calling party. An example of such calling party-based advanced routing includes the routing of calls originated by a roaming subscriber in a mobile communications network. In one mobile network embodiment, a mobile operator may choose to route calls originated by a foreign roaming subscriber (i.e., a mobile subscriber owned by another mobile operator) over lower cost/lower quality network resources. As such, a mobile switching center (MSC) receives a call request from a foreign roaming subscriber. The MSC switching office generates an LRN based query, such as an NP query, where the NP query includes an identifier associated with the calling party (e.g., CgPN). The LRN based query is processed in a manner similar to that described above with respect to called party-based query embodiments. In this case, the calling party identifier is used by the advanced routing SCP, to determine a carrier ID. The calling party identifier and/or carrier ID are subsequently used by the advanced routing LRN function to determine a corresponding LRN for the call. The LRN is returned to the originating MSC, and the MSC uses the LRN to initiate setup of the call. In this manner, calls originated by foreign roaming subscribers may be selectively allocated lower cost/quality resources than those calls originated by subscribers serviced/owned by the mobile operator.

In yet another embodiment, the originating MSC is adapted to include both the calling party and called party identifiers in the LRN based query message. For example, the calling and called party numbers may be carried in separated parameters within the query message, or the calling and called party numbers may be concatenated and placed in a single parameter. The called and calling party identifiers may be used in conjunction by either the advanced routing SCP or the advanced routing LRN function to determine QoS/routing for the call. For example, a mobile operator may allocate high cost/quality resources to a call originated by a foreign roaming subscriber if the called party is a subscriber of the mobile operator. A signaling message routing node according to the subject matter disclosed herein may include an underlying hardware platform that performs functions similar to that of a traditional telecommunications network packet routing node, such as an SS7-capable signal transfer point (STP) routing node. For example, a suitable system for providing number portability-based least cost routing services in a communications network according to the subject matter disclosed herein may include an EAGLE® STP (commercially available from Tekelec of Morrisville, N.C.).

### Foreign Roaming Mobile Subscriber Advanced Routing

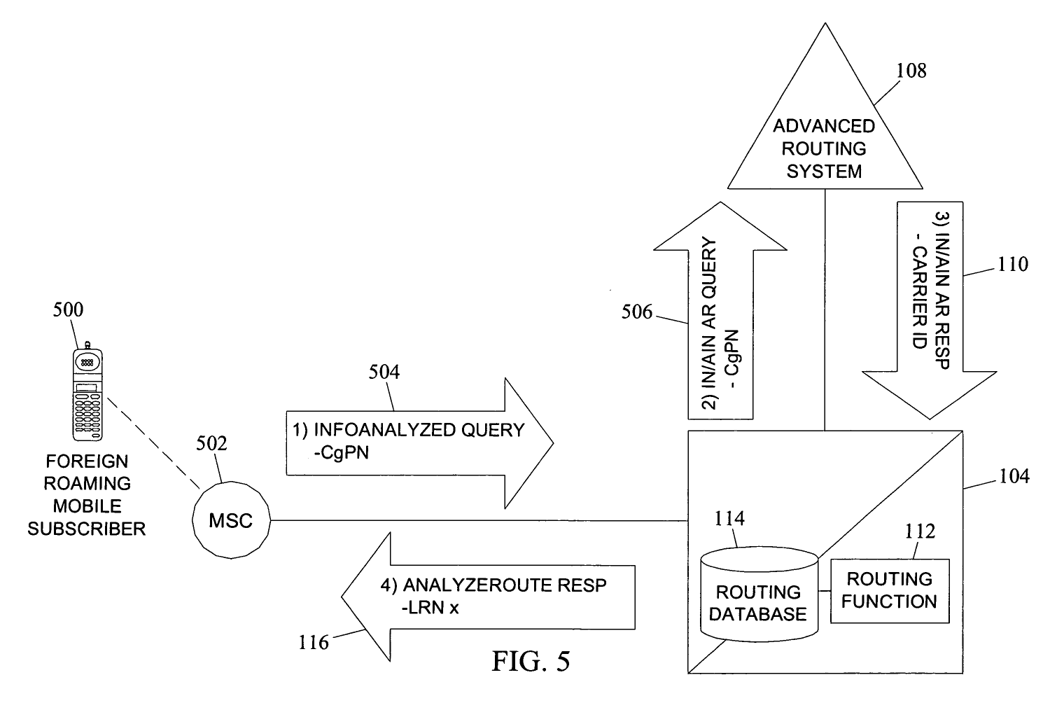

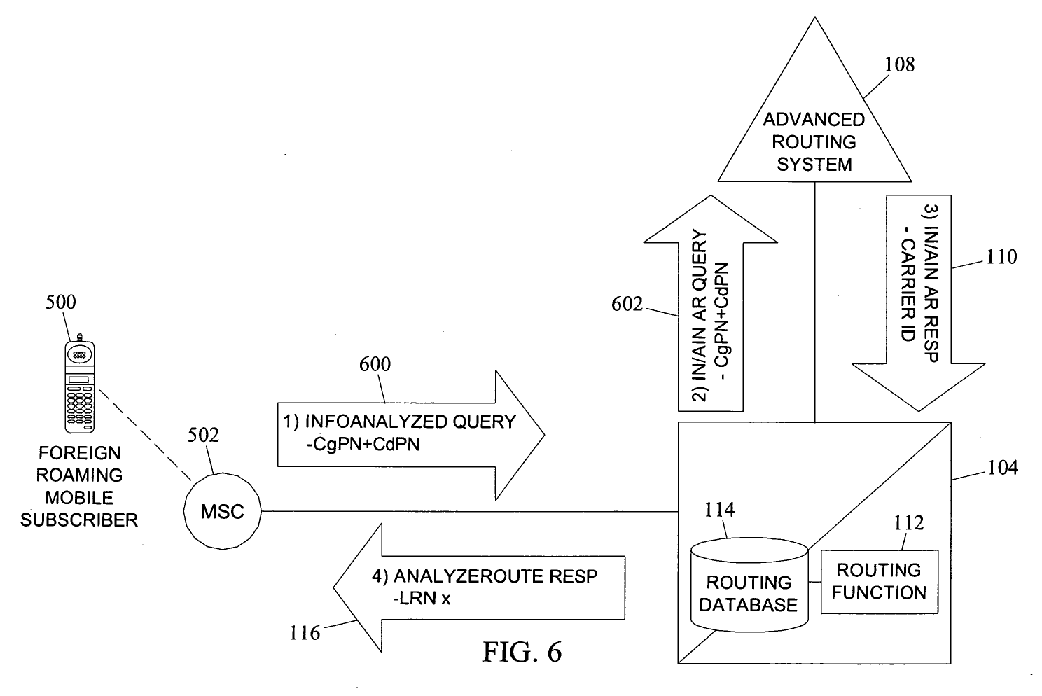

FIGS. 5 and 6 are exemplary systems for using a location routing number based query and response mechanism to effect advanced routing for a foreign roaming mobile subscriber according to an embodiment of the subject matter described herein. Referring to FIG. 5, a foreign roaming mobile subscriber device 500 is connected to mobile switching center (MSC) 502. In this example, subscriber 500 generates an LRN based query, such as InfoAnalyzed Query including CgPN 504, which is transmitted via MSC 502 to routing node 104. Upon receiving query 504, node 104 generates advanced routing query 506 including the CgPN and transmits query 506 to AR 108. AR 108 responds to query 506 by generating response message 110, which is received by node 104. Similar to the processes described above, routing function 112 and routing database 114 generate an LRN based response 116 based on information received from query 504, advanced response 110, and information stored in routing database 114. LRN based response 116 is then transmitted to MSC 502, where it may be used to connect the call associated with foreign roaming mobile subscriber 500.

Referring to FIG. 6, MSC 502 generates LRN based query 600 similar to query 504. However, LRN based query 600 includes both a CgPN and the CdPN. Therefore, both a CgPN and the CdPN are transmitted to AR 108 included in query 602, and are used by routing function 112 to generate LRN based response 116.

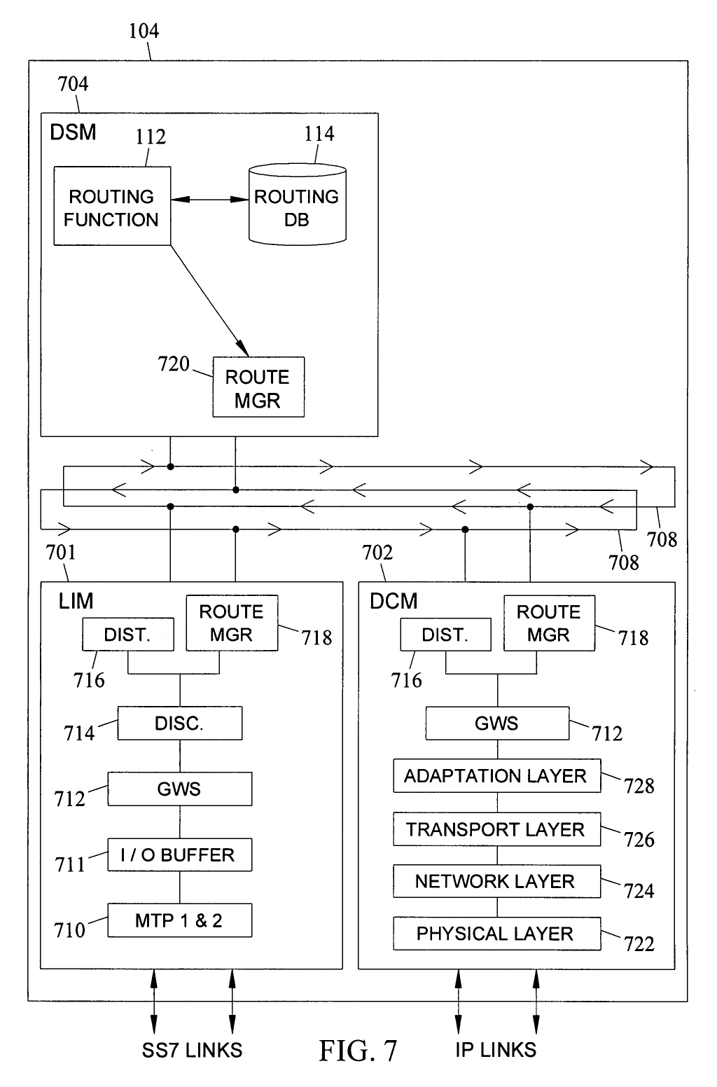

FIG. 7 illustrates a signaling message routing node 104 including an LRN based advanced routing function according an embodiment of the subject matter described herein. Referring to FIG. 7, signaling message routing node 104 includes an internal communications bus 708 that includes two counter-rotating serial rings. A number of processing modules or cards may be coupled to bus 708. In FIG. 7, bus 708 may be coupled to a link interface module (LIM) 701, a data communications module (DCM) 702, and a database service module (DSM) 704. These modules are physically connected to bus 708 such that signaling and other types of messages may be routed internally between active cards or modules. For simplicity of illustration, only a single LIM, a single DCM, and a single DSM cards are included in FIG. 7. However, signaling message routing node 104 may include multiple other LIMs, DCMs, DSMs, and other cards, all of which may be simultaneously connected to and communicating via bus 708.

Each module 701, 702, and 704 may execute the applications or functions that reside on each module and control communication with other modules via bus 708. For example, DSM 704 may execute software that determines an LRN based on a communications service subscriber identifier and associated least cost routing information.

LIM 701 may include an SS7 MTP level 1 and 2 function 710, an I/O buffer 711, a gateway screening (GWS) function 712, a message discrimination function 714, a message distribution function 716, and a route manager 718. MTP level 1 and 2 function 710 sends and receives digital data over a particular physical interface, provides error detection, error correction, and sequenced delivery of SS7 message packets. I/O buffer 711 provides temporary buffering of incoming and outgoing signaling messages.

GWS function 712 examines received message packets and determines whether the message packets should be allowed into signaling message routing node 104 for processing and/or routing. Discrimination function 714 performs discrimination operations, which may include determining whether the received message packet requires processing by an internal processing subsystem or is simply to be through switched (i.e., routed on to another node in the network). Messages that are permitted to enter signaling message routing node 104, such as LRN based queries, may be routed to other communications modules in the system or distributed to an application engine or processing module via bus 708.

DSM 704 may receive LRN based queries from LIM 701 via message distribution function 716. Distribution function 716 located on LIM 701 may forward LRN based queries to DSM 704 via bus 708. Upon receiving an LRN based query, routing function 112 may perform a lookup in routing database 114 to determine an LRN based on the CSSI contained in the LRN based query. Routing database 114 may contain routing information, such as least cost routing information illustrated in Tables 1 and 2 above. As illustrated in Tables 1 and 2, least cost routing information may include carrier IDs, called party numbers, times, and LRNs. Upon determining an LRN based on a received LRN based query, routing function 112 may generate an LRN based response including the determined LRN, and forward the response message to DCM 702 via bus 708 and route manager 720.

DCM 702 includes functionality for sending and receiving SS7 messages over IP signaling links. In the illustrated example, DCM 702 includes a physical layer function 722, a network layer function 724, a transport layer function 726, an adaptation layer function 728, and functions 712, 716, and 718 described above with regard to LIM 701. Physical layer function 722 performs open systems interconnect (OSI) physical layer operations, such as transmitting messages over an underlying electrical or optical interface. In one example, physical layer function 722 may be implemented using Ethernet. Network layer function 724 performs operations, such as routing messages to other network nodes. In one implementation, network layer function 724 may implement Internet protocol. The transport layer function 726 implements OSI transport layer operations, such as providing connection oriented transport between network nodes, providing connectionless transport between network nodes, or providing stream oriented transport between network nodes. Transport layer function 726 may be implemented using any suitable transport layer protocol, such as stream control transmission protocol (SCTP), transmission control protocol (TCP), or user datagram protocol (UDP). Adaptation layer function 728 performs operations for sending and receiving SS7 messages over IP transport. Adaptation layer function 728 may be implemented using any suitable IETF or other adaptation layer protocol. Examples of suitable protocols include MTP level 2 peer-to-peer user adaptation layer (M2PA), MTP level 3 user adaptation layer (M3UA), and/or signaling connection control part (SCCP) user adaptation layer (SUA). Functions 712, 716, and 718 perform the same operations as the corresponding components described above with regard to LIM 701.

It will be understood that various details of the subject matter described herein may be changed without departing from the scope of the subject matter described herein. Furthermore, the foregoing description is for the purpose of illustration only, and not for the purpose of limitation.

What is claimed is:

1. A method for using a location routing number (LRN) based query and response mechanism to effect advanced routing, the method comprising:
(a) receiving an LRN based query;
(b) generating an advanced routing query based on the LRN based query;
(c) sending the advanced routing query to an advanced routing function configured to process the advanced routing query;
(d) receiving an advanced routing response including a carrier ID from the advanced routing function;
(e) determining an LRN based on the advanced routing query response; and
(f) in response to determining the LRN, generating an LRN based response including the determined LRN.

2. The method of claim 1 wherein the LRN based query comprises a number portability (NP) query and the LRN based response comprises a NP response.

3. The method of claim 1 wherein generating an advanced routing query includes generating a least cost routing (LCR) query.

4. The method of claim 1 wherein generating an advanced routing query includes generating an advanced routing query based on a calling party identifier.

5. The method of claim 1 wherein sending the advanced routing query to an advanced routing function includes sending a quality of service (QoS) query to a QoS function.

6. The method of claim 1 wherein determining an LRN based on the advanced routing response includes performing a lookup in a data structure comprising LRNs, carrier ID values, called party numbers (CdPN), and times.

7. The method of claim 1 wherein generating an LRN based response includes inserting an LRN associated with a matching entry in a routing database into the LRN based response.

8. The method of claim 1 comprising sending the LRN based response to the LRN based query originator.

9. The method of claim 1 wherein steps (a)-(f) are performed at a routing node.

10. A method for using a location routing number (LRN) based query and response mechanism to effect advanced routing, the method comprising:
(a) receiving an LRN based query including a communications service subscriber identifier (CSSI);
(b) determining an LRN based on the CSSI and associated advanced routing information; and
(c) in response to determining the LRN, generating an LRN based response including the determined LRN.

11. The method of claim 10 wherein the LRN based query comprises a number portability (NP) query and the LRN based response comprises a NP response.

12. The method of claim 10 wherein receiving an LRN based query including a CSSI includes receiving an LRN based query including a called party identifier.

13. The method of claim 10 wherein determining an LRN includes determining an LRN based on a calling party identifier.

14. The method of claim 10 wherein determining an LRN includes determining an LRN based on quality of service (QoS) information.

15. The method of claim 10 wherein determining an LRN includes performing a lookup in a data structure comprising LRNs, called party numbers (CdPN), and times.

16. The method of claim 10 wherein steps (a)-(f) are performed at a routing node.

17. A signaling message routing node for using a location routing number (LRN) based query and response mechanism to effect advanced routing, the signaling message routing node comprising:
(a) a communications module for receiving an LRN based query; and
(b) a routing function for generating an advanced routing query based on the LRN based query, for sending the advanced routing query to an advanced routing function configured to process the advanced routing query, for receiving an advanced routing response including a carrier ID, for determining an LRN using the advanced routing response, and for generating an LRN based response including the determined LRN.

18. The signaling message routing node of claim 17 wherein the LRN based query comprises a number portability (NP) query and the LRN based response comprises a NP response.

19. The signaling message routing node of claim 17 wherein the advanced routing query comprises a least cost routing (LCR) query.

20. The signaling message routing node of claim 17 wherein the routing function is configured to perform a lookup in a data structure comprising LRNs, carrier ID values, called party numbers (CdPN), and times.

21. The signaling message routing node of claim 17 wherein the routing function is configured to insert an LRN associated with the matching entry into the LRN based response.

22. A signaling message routing node for using a location routing number (LRN) based query and response mechanism to effect advanced routing, the signaling message routing node configured to:
(a) a communications module for receiving an LRN based query including a communications service subscriber identifier (CSSI); and
(b) a routing function for determining an LRN based on the CSSI and associated advanced routing information and for generating a LRN based response including the determined LRN.

23. The signaling message routing node of claim 22 wherein the LRN based query comprises a number portability (NP) query and the LRN based response comprises a NP response.

24. The signaling message routing node of claim 22 wherein the routing function is configured to determine the LRN based on a called party identifier.

25. The signaling message routing node of claim 22 wherein the routing function is configured to perform a lookup in a data structure comprising LRNs, called party numbers (CdPN), and times to determine the LRN.

26. The signaling message routing node of claim 22 wherein the routing function is configured to send the LRN based response to an LRN based query originator.

27. A computer program product comprising computer executable instructions embodied in a computer readable medium for performing steps comprising:
(a) receiving a location routing number (LRN) based query;
(b) generating an advanced routing query based on the LRN based query;
(c) sending the advanced routing query to an advanced routing function configured to process the advanced routing query;
(d) receiving an advanced routing response including a carrier ID from the advanced routing function;
(e) determining an LRN based on the advanced routing response; and
(f) in response to determining the LRN, generating an LRN based response including the determined LRN.

28. The computer program product of claim 27 wherein the LRN based query comprises a number portability (NP) query and the LRN based response comprises a NP response.

29. A computer program product comprising computer executable instructions embodied in a computer readable medium for performing steps comprising:
(a) receiving a location routing number (LRN) based query including a communications service subscriber identifier (CSSI);
(b) determining an LRN based on the CSSI and associated advanced routing information; and
(c) in response to successfully determining an LRN, generating a LRN based response including the determined LRN.

30. The computer program product of claim 29 wherein the LRN based query comprises a number portability (NP) query and the LRN based response comprises a NP response.
